(19) United States
(12) Patent Application Publication
(10) Pub. No.: US 2025/0219360 A1
(43) Pub. Date: Jul. 3, 2025

(54) SPARK PLUG

(71) Applicant: Niterra Co., Ltd., Nagoya-shi (JP)

(72) Inventors: Satoshi NOGUCHI, Nagoya-shi (JP); Ritsuka NAKAGAWA, Nagoya-shi (JP); Tatsuya GOZAWA, Nagoya-shi (JP); Daiki GOTO, Nagoya-Aichi (JP); Susumu IMAI, Nagoya-shi (JP)

(73) Assignee: Niterra Co., Ltd., Nagoya-shi (JP)

(21) Appl. No.: 18/976,414

(22) Filed: Dec. 11, 2024

(30) Foreign Application Priority Data
Dec. 27, 2023 (JP) 2023-220214
Sep. 25, 2024 (JP) 2024-166296

(51) Int. Cl. H01T 13/06

(52) U.S. Cl. CPC H01T 13/06

(57) ABSTRACT

A spark plug includes: a metal shell having a cylindrical shape extending along an axial line, the metal shell including a front end being open; and a cover having one or more injection holes passing through the cover, the cover closing the front end of the metal shell. In at least one of the one or more injection holes, in a section including a center line of the at least one injection hole and parallel to the axial line, a distance in an axial direction between, of two intersection points at which an outer surface of the cover and the at least one injection hole intersect, a first intersection point on a front end side and a front end of the cover is 1 mm or more.

### FIELD OF THE INVENTION

The present invention relates to a spark plug including a cover closing an opening of a front end of a metal shell.

### BACKGROUND OF THE INVENTION

A known spark plug includes a metal shell having a cylindrical shape and being open at a front end and a cover closing such an opening of the front end of the metal shell, and the cover has an injection hole passing through the cover Japanese Unexamined Patent Application Publication No. 2020-159355. This type of spark plug ignites the fuel gas that has entered the cover through the injection hole, injects a gas flow including the generated flame into a combustion chamber through the injection hole, and burns the fuel gas in the combustion chamber.

When the amount of the fuel gas entering the cover through the injection hole is small, a large amount of the burned gas remains in the cover, and the concentration of the fuel gas is not increased. Thus, the fuel gas may be failed to be ignited, and a flame may be failed to be generated. In that case, the gas flow is not injected into the combustion chamber through the injection hole, and the gas flow loses momentum, which lead to unstable combustion of the fuel gas in the combustion chamber.

The present invention has been made to solve the above problem, and it is an object of the present invention to provide a spark plug capable of improving combustion stability.

### SUMMARY OF THE INVENTION

A first aspect to achieve the object is a spark plug including: a metal shell having a cylindrical shape extending along an axial line, the metal shell including a front end being open; and a cover having one or more injection holes passing through the cover, the cover closing the front end of the metal shell. In at least one of the one or more injection holes, in a section including a center line of the at least one injection hole and parallel to the axial line, a distance in an axial direction between, of two intersection points at which an outer surface of the cover and the at least one injection hole intersect, a first intersection point on a front end side and a front end of the cover is 1 mm or more.

In accordance with a second aspect, in the first aspect, the distance is 5 mm or less.

In accordance with a third aspect, in the first or second aspect, in the section, an angle formed by the at least one injection hole including the first intersection point and the outer surface of the cover is 57° or more and 123° or less.

In accordance with a fourth aspect, in any one of the first to third aspects, the front end of the cover exists on the section, and, in the section, a length of a shortest line segment of line segments connecting the first intersection point and the front end of the cover is larger than a maximum value, excluding infinity, of a curvature radius of a line of the outer surface of the cover connecting the first intersection point and the front end of the cover.

In accordance with a fifth aspect, in any one of the first to fourth aspects, the front end of the cover exists on the section, and, in the section, a line of the outer surface of the cover connecting the first intersection point and the front end of the cover includes a line segment starting from the first intersection point.

In accordance with a sixth aspect, in any one of the first to fifth aspects, at least a portion, of the outer surface of the cover, on the front end side relative to the at least one injection hole includes a conical surface whose diameter decreases toward the front end of the cover.

According to the present invention, since the distance in the axial direction between the first intersection point at which the outer surface of the cover and the injection hole intersect and the front end of the cover is 1 mm or more, a large flow of fuel gas moving along the front end of the cover and a small flow of the fuel gas being about to enter the cover through the injection hole are suppressed from merging, and the amount of flow of the fuel gas entering the cover through the injection hole can be ensured. The concentration of the fuel gas in the cover at the time of ignition can be increased, and the stability of the ignition of the fuel gas and the generation of a flame is thereby increased. The stability of the injection of the gas flow is increased, and the combustion stability can thereby be improved.

### BRIEF DESCRIPTION OF THE DRAWINGS

FIG. 1 is a partial sectional view of a spark plug according to a first embodiment.

FIG. 2 is a sectional view of the spark plug while the region of a cover is enlarged.

FIG. 3 is a schematic view of flows in a combustion chamber.

FIG. 4 is a sectional view of a spark plug according to a second embodiment.

FIG. 5 is a sectional view of a spark plug according to a third embodiment.

### DETAILED DESCRIPTION OF THE INVENTION

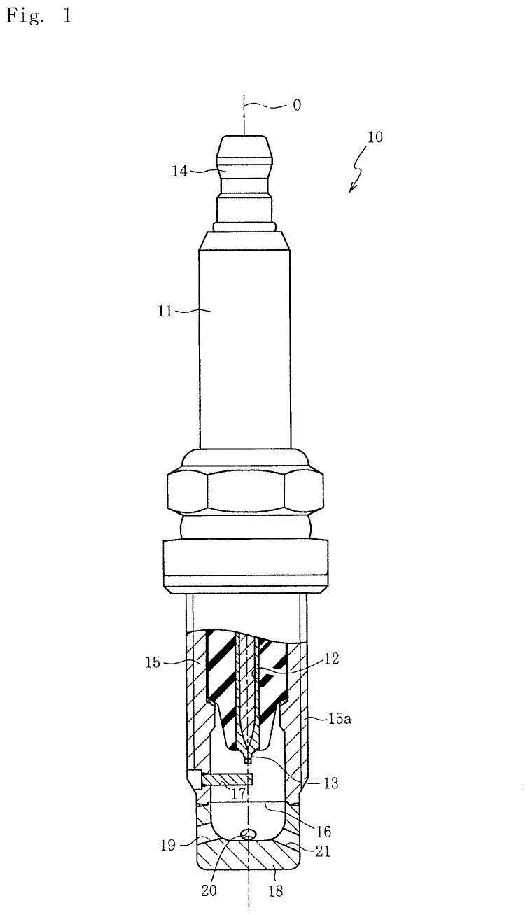

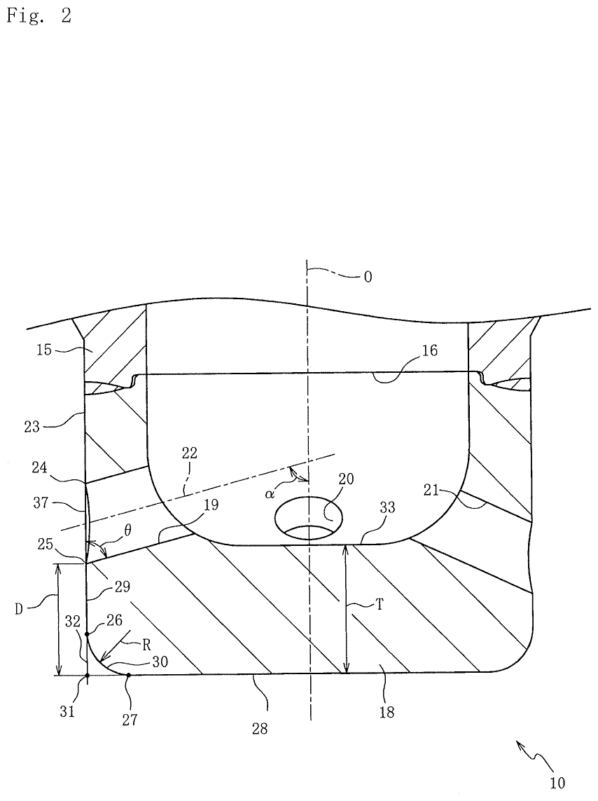

Hereinafter, preferred embodiments of the present invention will be described with reference to the accompanying drawings. FIG. 1 is a partial sectional view of a spark plug 10 according to a first embodiment. FIG. 1 illustrates a section, of a portion of the spark plug 10 on the front end side, including an axial line O. The lower side on the paper sheet of FIG. 1 is referred to as the front end side of the spark plug 10, and the upper side on the paper sheet of FIG. 1 is referred to as the rear end side of the spark plug 10 (the same applies to FIGS. 2 to 4).

As FIG. 1 illustrates, the spark plug 10 includes an insulator 11, a metal shell 15, and a cover 18. The insulator 11 is a substantially cylindrical member having an axial hole 12 extending along the axial line O and is made of ceramics, such as alumina, excellent in mechanical property and excellent in insulation performance under high temperature. A center electrode 13 is disposed in a front end-side region of the axial hole 12 of the insulator 11. A tip of the center electrode 13 projects from the insulator 11 to the front end side.

In the axial hole 12, a metal terminal 14 is electrically connected to the center electrode 13. The metal terminal 14 is a rod-shaped member to which a power source (not illustrated) is connected, and the metal terminal 14 is made of a conductive metal material (such as low-carbon steel). The metal terminal 14 is fixed to a rear end of the insulator 11.

The metal shell 15 is a substantially cylindrical member made of a conductive metal material (such as low-carbon steel) and extending along the axial line O. An external thread 15a is provided in an outer periphery of the metal shell 15. The metal shell 15 is disposed on an outer periphery of the insulator 11. A front end 16 of the metal shell 15 is positioned on the front end side relative to the center electrode 13, and the front end 16 is open.

A ground electrode 17 is disposed on the metal shell 15. The ground electrode 17 is a rod-shaped member of a metal containing one or more types of, for example, Pt, Ni, and Ir as a main component. A portion of the ground electrode 17 is opposite to the center electrode 13, and a spark gap is provided between the center electrode 13 and the ground electrode 17.

The cover 18 closing the opening of the front end 16 of the metal shell 15 is connected to the metal shell 15. Examples of the material of the cover 18 include a metal material containing one or more types of, for example, Fe, Ni, and Cu as a main component. In the present embodiment, the cover 18 is welded to the metal shell 15. The cover 18 has injection holes 19, 20, and 21 passing through the cover 18 in a thickness direction. The injection holes 19, 20, and 21 radially extend from the axial line O.

Although such three injection holes 19, 20, and 21 are illustrated in the present embodiment, the provision of at least one injection hole is sufficient. The number of the injection holes is set appropriately. The shape of a section of each of the injection holes 19, 20, and 21 is also set appropriately. Examples of the shape of a section of each of the injection holes 19, 20, and 21 include a circle, an ellipse, a polygon, and a polygon having a rounded corner.

Although the cover 18 including an outer surface 23 including a cylindrical surface is illustrated in the present embodiment, the shape of the outer surface 23 of the cover 18 is set appropriately. Examples of the shape of the outer surface 23 of the cover 18 include a shape including one or more of a conical surface, a spherical zone, and a spherical cap and a shape into which two or more of the above-described three parts are combined.

In the spark plug 10 installed to an engine (not illustrated), fuel gas (an air-fuel mixture generated in a combustion chamber) enters inside the cover 18 through the injection holes 19, 20, and 21 by a rise of a piston and a valve operation in a compression stroke. The spark plug 10 generates a flame kernel due to discharge between the center electrode 13 and the ground electrode 17. When growing, such a flame kernel ignites and burns the fuel gas. The expansion pressure generated by the combustion of the fuel gas generates a gas flow including a flame and injects the gas including the flame into the combustion chamber through the injection holes 19, 20, and 21. With the jet of the flame, the fuel gas in the combustion chamber is burned (exploded) and pushes the piston downward.

FIG. 2 is a sectional view of the spark plug 10 while the region of the cover 18 is enlarged and illustrates a section of the spark plug 10 taken along a plane including a center line 22 of the injection hole 19 and parallel to the axial line O. Since the planes parallel to the axial line O also include a plane including the axial line O, FIG. 2 illustrates the section including the center line 22 of the injection hole 19 and the axial line O as an example of the plane parallel to the axial line O.

The outer surface 23 of the cover 18 (the surface appears in the combustion chamber of the engine) includes a second intersection point 24 at which the outer surface 23 and the injection hole 19 intersect, a first intersection point 25, a point 26, and a point 27 that are arranged in this order toward the front end side. The point 27 is included in a front end 28 of the cover 18. The front end 28 is a substantially circular surface vertical to the axial line O. The first intersection point 25 is an intersection point, of the two intersection points at which the outer surface 23 and the injection hole 19 intersect, positioned on the front end side. The point 26 is an endpoint of a line segment 29 starting from the first intersection point 25. The point 27 is an endpoint of a circular arc 30 starting from the point 26. A distance D in the axial direction between the first intersection point 25 of the injection hole 19 and the front end 28 of the cover 18 is 1 mm or more.

In the section including a center line of the injection hole 21 (not illustrated) and the axial line O, a distance in the axial direction between a front end-side intersection point, of the intersection points at which the injection hole 21 and the outer surface 23 intersect, and the front end 28 may be less than 1 mm. Similarly, in the section including a center line of the injection hole 20 (not illustrated) and the axial line O, a distance in the axial direction between a front end-side intersection point, of the intersection points at which the injection hole 20 and the outer surface 23 intersect, and the front end 28 may also be less than 1 mm. The provision of one injection hole 19 with a distance D of 1 mm or more in the cover 18 is sufficient.

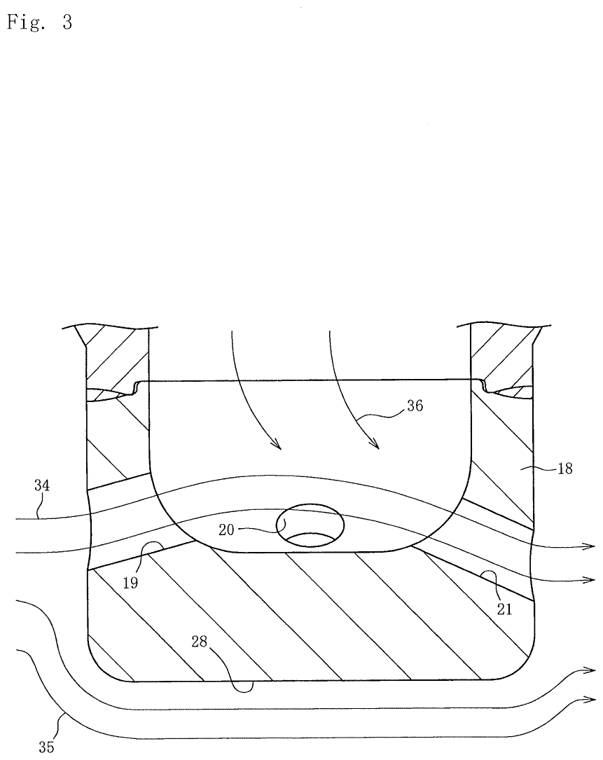

FIG. 3 is a schematic view of flows of gas in the combustion chamber of the engine (not illustrated). The fuel gas flows inside the combustion chamber by a rise of the piston and the valve operation in the compression stroke. Such flows of the fuel gas include a small flow 34 entering inside the cover 18 through the injection hole 19 and a large flow 35 moving along the front end 28 of the cover 18. When the distance D in the axial direction between the first intersection point 25 of the injection hole 19 (refer to FIG. 2) and the front end 28 of the cover 18 is 1 mm or more, the flow 34 that merges with the large flow 35 can be reduced, and the amount of the flow 34 entering the cover 18 through the injection hole 19 can be ensured. Thus, with the flow 34, burned gas 36 is exhausted outside the cover 18 through the injection holes 20 and 21, and the flow 34 can increase the concentration of the fuel gas in the cover 18. Accordingly, the stability of the ignition of the fuel gas and the generation of a flame that occur in the cover 18 is increased. The stability of the generation of the gas flows including a flame and injected into the combustion chamber through the injection holes 19, 20, and 21 is increased, and the combustion stability can thereby be improved.

Description here will be made with reference again to FIG. 2. The distance D is preferably 1 mm or more and 5 mm or less. In the case where multiple injection holes each with a distance D of 1 mm or more are provided, the longest distance D is preferably 5 mm or less. This is because the thermal capacity of a portion of the cover 18 including the front end 28 is increased when the distance D is more than 5 mm, and the front end 28 is hardly cooled and may thereby be a source of pre-ignition.

Similarly, a thickness T between a bottom 33 of the cover 18 on the front end side and the front end 28 (a length of a portion of the axial line O cut out by the bottom 33 and the front end 28) is preferably 5 mm or less. This is because the thermal capacity of a portion of the cover 18 including the front end 28 is increased when the thickness T is more than 5 mm, and the front end 28 and the bottom 33 are hardly cooled and may thereby be a cause of pre-ignition.

A line segment 37 connecting the first intersection point 25 and the second intersection point 24 is seen as the outer surface 23 of the cover 18, and an angle θ formed by the injection hole 19 including the first intersection point 25 and the line segment 37 (the outer surface 23) is determined. The angle θ formed by the injection hole 19 and the outer surface 23 is preferably 57° or more and 123° or less. The reason for this is as follows: the length of the injection hole 19 can be shortened compared with the case where the angle θ falls outside the above-described range, thereby reducing a loss in the energy of the flow 34 (refer to FIG. 3) caused by the friction of the injection hole 19 and a loss (cooling loss) in the energy possessed by the burned gas caused due to passing, through the injection hole 19, via the cover 18, the metal shell 15, and the engine to be wasted as heat. Thus, the combustion stability can further be improved.

An angle α formed by the center line 22 of the injection hole 19 and the axial line O is preferably less than 90°. This is for burning the fuel gas in the combustion chamber in an instant by injecting the gas flow into the combustion chamber through the injection hole 19 toward the front end side of the cover 18.

A length of the injection hole 19 starting from the first intersection point 25 is preferably smaller than the thickness T. This is for improving the combustion stability by reducing the energy loss caused by the friction of the injection hole 19 and the cooling loss due to the injection hole 19.

A line, of the outer surface 23 of the cover 18, constituted by the line segment 29 and the circular arc 30 (hereinafter, referred to as a “line 29-30”) connects the first intersection point 25 and the front end 28. The curvature radius of the line segment 29 is infinite, and the circular arc 30 has a curvature radius R; thus, a maximum value, excluding infinity, of the curvature radius of the line 29-30 is R.

Since the circular arc 30 exists between the line segment 29 and the front end 28, a line segment constituted by the line segment 29 and a line segment 32 connecting an intersection point 31 at which a straight line including the line segment 29 and a straight line including the front end 28 intersect to the point 26 (hereinafter, referred to as a “line segment 29-32”) is defined as the shortest line segment of the line segments connecting the first intersection point 25 and the front end 28. This is for reducing an influence of the circular arc 30 on the length of the line segment (line segment 29-32) connecting the first intersection point 25 and the front end 28.

In comparison between the length of the line segment 29-32 (equal to the distance D in the present embodiment) and the maximum value R, excluding infinity, of the curvature radius of the line 29-30, the line segment 29-32 is preferably larger. This is because the flow 34 merging with the flow 35 (refer to FIG. 3) can be reduced in the case where the line segment 29-32 is larger than the maximum value R of the curvature radius. Since the amount of the flow 34 can be ensured, the flow 34 can increase the concentration of the fuel gas in the cover 18 by exhausting the burned gas 36 outside the cover 18 through the injection holes 20 and 21. The stability of the ignition of the fuel gas and the generation of a flame that occur in the cover 18 is increased, and the stability of the gas flows from the injection holes 19, 20, and 21 is thereby increased, which can improve the combustion stability.

Since the line 29-30 includes the line segment 29 starting from the first intersection point 25, compared with the case where the entire line 29-30 is a continuous circular arc without the line segment 29, the flow 34 merging with the flow 35 (refer to FIG. 3) can be reduced. The amount of the flow 34 is ensured, and the concentration of the fuel gas in the cover 18 at the time of ignition can be increased. Thus, the stability of the ignition and the generation of a flame is increased, and the stability of the gas flows from the injection holes 19, 20, and 21 is increased. Accordingly, the combustion stability can be improved.

In the spark plug 10, since the outer circumference of the cover 18 decreases as the nominal diameter of the external thread 15a of the metal shell 15 decreases, the size of the injection hole 19 that can be provided in the cover 18 is decreased in view of, for example, the mechanical strength of the cover 18, and the amount of the fuel gas entering inside the cover 18 through the injection hole 19 at the time of the compression stroke is decreased. Due to such a tendency, the effect of improving the combustion stability is magnified particularly in the case where the nominal diameter of the external thread 15a is 14 mm or less. This is because the amount of the flow 34 entering inside the cover 18 through the injection hole 19 can be ensured even when the spark plug 10 has the small injection hole 19. The diameter of the outer surface 23 of the cover 18 at this time, for example, 12.5 mm or less.

In the fuel that is ignited by the spark plug 10, the effect of improving the combustion stability is magnified in the case of gasoline rather than the case of a gas such as a compressed natural gas (CNG) having good ignitability. This is because the flame kernel generated by discharge easily disappears inside the cover 18 when the amount of gasoline in the fuel gas (air-fuel mixture) that has entered inside the cover 18 through the injection hole 19 cannot be ensured.

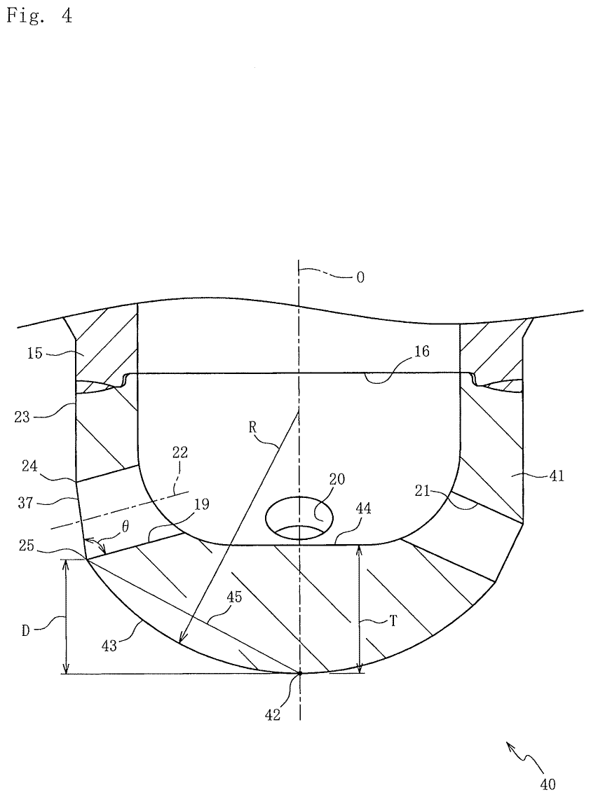

A second embodiment will be described with reference to FIG. 4. The case where the outer surface 23 of the cover 18 includes the line segment 29 starting from the first intersection point 25 is described in the first embodiment. In contrast, in the second embodiment, the case where, in a section taken along a plane including a center line 22 of an injection hole 19 and parallel to an axial line O, a front end 42 of a cover 41 and a first intersection point 25 are connected by a circular arc 43 will be described. The same parts as those described in the first embodiment are denoted by the same reference signs, and the description thereof will hereinafter be omitted.

FIG. 4 is a sectional view of a spark plug 40 in the second embodiment while the region of the cover 41 is enlarged and illustrates the section of the spark plug 40 taken along the plane including the center line 22 of the injection hole 19 and parallel to the axial line O. The cover 41 closes an opening of a front end 16 of a metal shell 15.

An outer surface 23 of the cover 41 includes the first intersection point 25 at which the outer surface 23 and the injection hole 19 intersect and the circular arc 43 connecting the first intersection point 25 and the front end 42. A distance D in the axial direction between the first intersection point 25 of the injection hole 19 and the front end 42 is 1 mm or more. Thus, a flow 34 merging with a flow 35 (refer to FIG. 3) is reduced, and the amount of the flow 34 entering the cover 41 through the injection hole 19 can be ensured. The stability of the ignition of the fuel gas and the generation of a flame that occur in the cover 41 is increased, and the stability of the generation of the gas flows including a flame and injected into the combustion chamber through the injection holes 19, 20, and 21 is thereby increased, which can improve the combustion stability.

A thickness T between a bottom 44 of the cover 41 on the front end side and the front end 42 (a length of a portion of the axial line O cut out by the bottom 44 and the front end 42) is preferably 5 mm or less. This is because the thermal capacity of a portion of the cover 41 including the front end 42 is increased when the thickness T is more than 5 mm, and the front end 42 and the bottom 44 are hardly cooled and may thereby be a cause of pre-ignition.

An angle θ formed by the injection hole 19 including the first intersection point 25 and a line segment 37 (the outer surface 23) connecting the first intersection point 25 and a second intersection point 24 is preferably 57° or more and 123° or less. This is for further improving the combustion stability by reducing the loss caused by the friction of the injection hole 19 and the cooling loss.

In the cover 41, the length of a line segment 45 connecting the first intersection point 25 and the front end 42 is smaller than a maximum value R of the curvature radius of a line (the circular arc 43) connecting the first intersection point 25 and the front end 42. However, the combustion stability can be improved because the distance D is 1 mm or more.

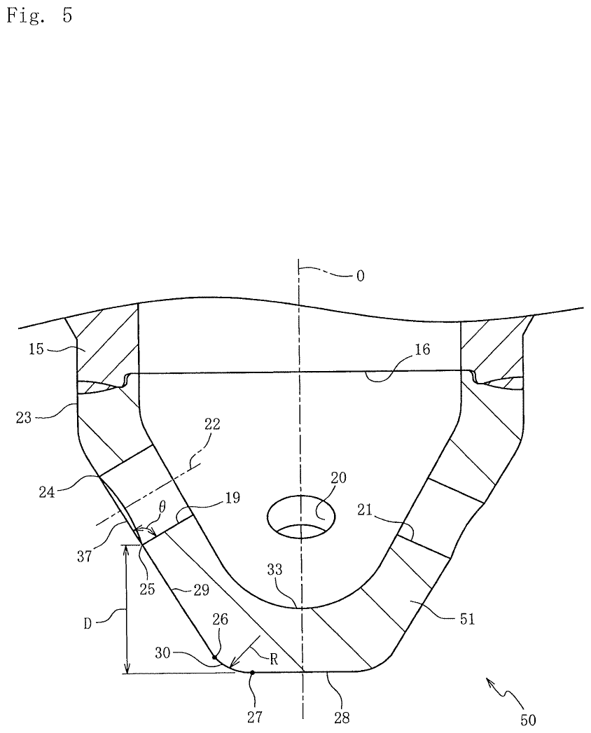

A third embodiment will be described with reference to FIG. 5. The case where the outer surface 23 of the cover 18 includes the cylindrical surface is described in the first embodiment. In contrast, in the third embodiment, the case where an outer surface 23 of a cover 51 includes a conical surface is described. The same parts as those described in the first embodiment are denoted by the same reference signs, and the description thereof will hereinafter be omitted.

FIG. 5 is a sectional view of a spark plug 50 in the third embodiment while the region of the cover 51 is enlarged and illustrates a section of the spark plug 50 taken along a plane including a center line 22 of an injection hole 19 and parallel to an axial line O. The cover 51 closes an opening of a front end 16 of a metal shell 15. A portion, of the outer surface 23 of the cover 51, on the front end side relative to the injection hole 19 includes a conical surface whose diameter decreases toward a front end 28 of the cover 51. According to the third embodiment, the combustion stability can be improved as with the first embodiment.

In addition, since the portion of the outer surface 23 of the cover 51 on the front end side relative to the injection hole 19 includes the conical surface, the area of the front end 28 can be decreased compared with the cover 18 (refer to FIG. 2) including the cylindrical surface having a diameter equal to the diameter of a portion of the conical surface positioned at the injection hole 19. The amount of a portion, of the fuel gas in the combustion chamber, hitting the front end 28 to return to the combustion chamber without entering the cover 51 through the injection hole 19 can be reduced, and the fuel gas can thereby be easily introduced into the cover 51 through the injection hole 19. The form of the cover 51 including the conical surface is effective particularly for the fuel gas flowing from the front end side of the cover 51.

### EXAMPLES

The present invention will be described in more detail by giving examples but is not limited to the examples.

### Sample Preparation

A tester prepared spark plugs of samples Nos. 1 to 12 in Table 1 in a way similar to the spark plug 10 in the first embodiment, and the tester prepared spark plugs of samples Nos. 13 to 20 in Table 2 in a way similar to the spark plug 50 in the third embodiment is formed.

The samples Nos. 1 to 12 and 13 to 20 differ in distance D between the intersection point 25 and the front end 28, angle θ formed by the injection hole 19 and the outer surface 23, length of the shortest line segment of the line segments connecting the intersection point 25 and the front end 28 (hereinafter, referred to as a “line segment length”), maximum value R, excluding infinity, of the curvature radius of the line connecting the intersection point 25 and the front end 28, and presence or absence of a line segment starting from the intersection point 25 (hereinafter, referred to as a “linear portion”). Each line segment length is set by changing the shape of the line connecting the intersection point 25 and the front end 28 and by changing an angle between the line connecting the intersection point 25 and the front end 28 and the axial line O.

The samples Nos. 1 to 12 have uniform dimensions and shapes of portions thereof other than the above listing and each include four injection holes in the cover 18. The samples Nos. 13 to 20 have uniform dimensions and shapes of portions thereof other than the above listing and each include four injection holes in the cover 51.

TABLE 1

| | | | line | | | | |
|---|---|---|---|---|---|---|---|
| | | | segment | | | | anti |
| | D | θ | length | R | linear | | pre- |
| No. | (mm) | (°) | (mm) | (mm) | portion | stability | ignition |
| 1 | 1.5 | 90 | 1.6 | 0.5 | presence | A | A |
| 2 | 1.5 | 90 | 2.5 | 2.0 | absence | B | A |
| 3 | 1.5 | 90 | 1.6 | 2.0 | presence | B | A |
| 4 | 1.0 | 57 | 2.0 | 2.0 | absence | C | A |
| 5 | 1.0 | 90 | 2.0 | 2.0 | absence | C | A |
| 6 | 1.0 | 123 | 2.0 | 2.0 | absence | C | A |
| 7 | 1.0 | 45 | 2.0 | 2.0 | absence | D | A |
| 8 | 1.0 | 50 | 2.0 | 2.0 | absence | D | A |
| 9 | 1.0 | 130 | 2.0 | 2.0 | absence | D | A |
| 10 | 5.0 | 45 | 6.0 | 6.0 | absence | D | B |
| 11 | 5.5 | 45 | 6.0 | 6.0 | absence | D | C |
| 12 | 0.5 | 45 | 1.4 | 2.0 | absence | E | A |

TABLE 2

| | | | line | | | | |
|---|---|---|---|---|---|---|---|
| | | | segment | | | | anti |
| | D | θ | length | R | linear | | pre- |
| No. | (mm) | (°) | (mm) | (mm) | portion | stability | ignition |
| 13 | 1.5 | 90 | 1.6 | 0.5 | presence | A | A |
| 14 | 1.2 | 90 | 2.3 | 2.0 | absence | B | A |
| 15 | 3.0 | 90 | 1.6 | 2.0 | presence | B | A |
| 16 | 1.0 | 57 | 2.0 | 2.0 | absence | C | A |
| 17 | 1.0 | 123 | 2.0 | 2.0 | absence | C | A |
| 18 | 1.0 | 45 | 2.0 | 2.0 | absence | D | A |
| 19 | 1.0 | 130 | 2.0 | 2.0 | absence | D | A |
| 20 | 5.0 | 45 | 6.0 | 10.0 | absence | D | B |

### Test 1

Test 1 is on combustion stability. The tester installed a sample to each cylinder of a supercharging four-cylinder direct-injection gasoline engine of 1.6-liter displacement, operated the engine, and calculated a coefficient of variance (COV) of an indicated mean effective pressure between cycles in operating the engine for 3000 cycles under the conditions of an engine revolution of 2000 rpm, a pressure of 1200 kPa, and an Air/Fuel ratio of 14.5.

A smaller COV indicates higher combustion stability. The sample with a COV less than 1.5% is judged as A (excellent), the sample with a COV of 1.5% or more and less than 2.0% is judged as B (very good), the sample with a COV of 2.0% or more and less than 2.5% is judged as C (good), the sample with a COV of 2.5% or more and less than 3.0% is judged as D (fair), and the sample with a COV of 3.0% or more is judged as E (poor). The results are in columns for stability in Table 1 and Table 2.

### Test 2

Test 2 is on anti pre-ignition. The tester installed a sample to each cylinder of a naturally aspirated four-cylinder gasoline engine of 1.3-liter displacement, operated the engine, and brought an intake throttle valve into a full throttle state. Whether pre-ignition occurs was examined by operating the engine for one minute so that a specific ignition timing is reached. If there was no pre-ignition, the engine was operated for one minute with advance by 2°, and such an operation was repeated until any pre-ignition occurred.

A larger crank angle at which pre-ignition occurs indicates less likelihood of pre-ignition. In the advance of a crank angle at which pre-ignition occurred, relative to a spark plug of an original equipment supplier (OES), without the cover 18, of the engine used in Test 2, the sample with an angle of 10° or more is judged as A (excellent), the sample with an angle of 5° or more and less than 10° is judged as B (good), and the sample with an angle less than 5° is judged as C (fair). The results are in columns for anti pre-ignition in Table 1 and Table 2.

### Evaluation

In Test 1 (combustion stability), the judgement results of the samples Nos. 1 to 11 and 13 to 20 are A to D, whereas the judgement result of the sample No. 12 is E. The distance D of each of the samples Nos. 1 to 11 and 13 to 20 is 1 mm or more, whereas the distance D of the sample No. 12 is less than 1 mm. It is presumed that the combustion stability was low in the sample No. 12 with a distance D less than 1 mm because the amount of flow of the fuel gas entering the cover through the injection hole was small. On the other hand, it is presumed that the combustion stability was high in the samples Nos. 1 to 11 and 13 to 20 with a distance D of 1 mm or more because the amount of flow of the fuel gas entering the cover through the injection hole was able to be ensured.

In Test 2 (anti pre-ignition), the judgement results of the samples Nos. 1 to 9 and 13 to 19 are A, whereas the judgement results of the samples Nos. 10 and 20 are B, and the judgement result of the sample No. 11 is C. The distance D of each of the samples Nos. 1 to 10 and 13 to 20 is 5 mm or less, whereas the distance D of the sample No. 11 exceeds 5 mm. It is presumed that the anti pre-ignition was low in the sample No. 11 with a distance D exceeding 5 mm because a portion of the cover including the front end was increased in thermal capacity and was hardly cooled. It is presumed that the anti pre-ignition was high in the samples Nos. 10 and 20 with a distance D of 5 mm because the heat conduction of a portion of the cover including the front end was improved, compared with the sample No. 11. It is presumed that the anti pre-ignition was even higher in the samples Nos. 1 to 9 and 13 to 19 because the distance D is less than 5 mm, compared with the samples Nos. 10 and 20.

In Test 1, the judgement results of the samples Nos. 1 to 6 and 13 to 17 are A to C, whereas the judgement results of the samples Nos. 7 to 11 and 18 to 20 are D. The angle θ of each of the samples Nos. 1 to 6 and 13 to 17 is 57° or more and 123° or less, whereas the angle θ of each of the samples Nos. 7 to 11 and 18 to 20 is less than 57° or more than 123°. It is presumed that the combustion stability was high in the samples Nos. 1 to 6 and 13 to 17 with an angle θ of 57° or more and 123° or less because the energy loss caused by the friction of the injection hole and the cooling loss due to the injection hole were reduced, compared with the samples Nos. 7 to 11 and 18 to 20 with an angle θ less than 57° or more than 123°.

In Test 1, the judgement results of the samples Nos. 1 to 3 and 13 to 15 are A and B, whereas the judgement results of the samples Nos. 4 to 6, 16, and 17 are C. The samples Nos. 1 to 3 and 13 to 15 have a line segment length larger than the curvature radius R or include the linear portion, whereas the samples Nos. 4 to 6, 16, and 17 have a line segment length equal to the curvature radius R or include no linear portion. It is presumed that the combustion stability was high in the samples Nos. 1 to 3 and 13 to 15 having a line segment length larger than the curvature radius R or including the linear portion because the amount of flow of the fuel gas entering the cover through the injection hole was able to be increased, compared with the samples Nos. 4 to 6, 16, and 17 having a line segment length equal to the curvature radius R or including no linear portion.

The combustion stability was excellent in the samples Nos. 1 and 13 having a line segment length larger than the curvature radius R and including the linear portion, compared with the samples Nos. 2 and 14 having a line segment length larger than the curvature radius R but including no linear portion and with the samples Nos. 3 and 15 including the linear portion but having a line segment length smaller than the curvature radius R. It has become clear that making the line segment length larger than the curvature radius R and the inclusion of the linear portion have an advantage for improving the combustion stability.

Although the present invention has so far been described with reference to the embodiments, the present invention is not limited to the above-described embodiments, and it is readily understood that various improvements and modifications may be made without departing from the spirit of the present invention.

Although the case where the ground electrode 17 having a linear shape is disposed at the position of the external thread of the metal shell 15 is described in the embodiments, this is not the only option. The ground electrode 17 may be disposed on the metal shell 15 or on a corresponding one of the covers 18, 41, and 51. The ground electrode 17 is not limited to the ground electrode having a linear shape. The ground electrode 17 may be bent. The case where the spark gap is provided between the front end side of the center electrode 13 and the ground electrode 17 is not the only option. The spark gap may be provided between the radially outer side of the center electrode 13 and the ground electrode 17.

Although the case where a corresponding one of the covers 18, 41, and 51 is welded to the metal shell 15 is described in the embodiments, this is not the only option. A cylindrical member having a cover at a front end may be prepared, and the cylindrical member may be connected to the metal shell 15. The cylindrical member is a cylindrical member whose front end is closed by the cover, and an inner peripheral surface of the cylindrical member has an internal thread coupled to the external thread of the metal shell 15. An outer peripheral surface of the cylindrical member has an external thread coupled to a threaded hole of the engine. By coupling the internal thread of the cylindrical member to the external thread of the metal shell 15, the cover is disposed on the front end side of the metal shell 15. The cover has an injection hole 19.

Means of disposing the cover on the front end side of the metal shell 15 by connecting the cylindrical member to the metal shell 15 is not limited to the means of coupling the internal thread in the inner peripheral surface of the cylindrical member to the external thread of the metal shell 15. Another means may be used to connect the cylindrical member to the metal shell. Examples of such another means include means of joining the cylindrical member and the metal shell by welding. Examples of the material of the cylindrical member include metal materials such as a nickel-based alloy and stainless steel, and ceramics such as silicon nitride.

### DESCRIPTION OF REFERENCE NUMERALS

10, 40, 50 spark plug
15 metal shell
16 front end of the metal shell
18, 41, 51 cover
19 injection hole
22 center line
23 outer surface
25 first intersection point
28, 42 front end of the cover
29 line segment
D distance
R curvature radius
θ angle

What is claimed is:

1. A spark plug comprising:
a metal shell having a cylindrical shape extending along an axial line, the metal shell including a front end being open; and
a cover having one or more injection holes passing through the cover, the cover closing the front end of the metal shell, wherein,
in at least one of the one or more injection holes, in a section including a center line of the at least one injection hole and parallel to the axial line, a distance in an axial direction between, of two intersection points at which an outer surface of the cover and the at least one injection hole intersect, a first intersection point on a front end side and a front end of the cover is 1 mm or more.

2. The spark plug according to claim 1, wherein
the distance is 5 mm or less.

3. The spark plug according to claim 1, wherein,
in the section, an angle formed by the at least one injection hole including the first intersection point and the outer surface of the cover is 57° or more and 123° or less.

4. The spark plug according to claim 1, wherein
the front end of the cover exists on the section, and,
in the section, a length of a shortest line segment of line segments connecting the first intersection point and the front end of the cover is larger than a maximum value, excluding infinity, of a curvature radius of a line of the outer surface of the cover connecting the first intersection point and the front end of the cover.

5. The spark plug according to claim 1, wherein
the front end of the cover exists on the section, and,
in the section, a line of the outer surface of the cover connecting the first intersection point and the front end of the cover includes a line segment starting from the first intersection point.

6. The spark plug according to claim 1, wherein
at least a portion, of the outer surface of the cover, on the front end side relative to the at least one injection hole includes a conical surface whose diameter decreases toward the front end of the cover.
